(19) United States
(12) Patent Application Publication
(10) Pub. No.: US 2023/0063544 A1
(43) Pub. Date: Mar. 2, 2023

(54) SPINDLE MOTOR AND HARD DISK DRIVE DEVICE

(71) Applicant: MINEBEA MITSUMI Inc., Nagano (JP)

(72) Inventor: Akira DAIRI, Kitasaku-gun (JP)

(21) Appl. No.: 17/820,043

(22) Filed: Aug. 16, 2022

(30) Foreign Application Priority Data
Aug. 27, 2021 (JP) 2021-138832
Jun. 17, 2022 (JP) 2022-097926

(51) Int. Cl. H02K 5/167; G11B 19/20; F16C 33/10

(52) U.S. Cl. CPC H02K 5/1677; G11B 19/2009; F16C 33/1095

(57) ABSTRACT

A spindle motor includes a shaft fixed to a base portion and a hub rotatably supported by the shaft. The hub is a cold-forged product made of low-carbon steel having a carbon content of 0.23 mass % or less.

### CROSS-REFERENCE TO RELATED APPLICATIONS

This application claims the benefit of priority to Japanese Patent Application Numbers 2021-138832, and 2022-097926 filed on Aug. 27, 2021, and Jun. 17, 2022, respectively. The entire contents of the above-identified applications are hereby incorporated by reference.

### TECHNICAL FIELD

The present disclosure relates to a spindle motor and a hard disk drive device, and particularly relates to a technique for forming a hub having a long axial length by cold forging.

### BACKGROUND

In a hard disk drive device using a spindle motor, a hub for placing a hard disk is formed of aluminum or stainless steel (DHS1 (registered trade name), for example) (see JP 2006-254625 A). Conventionally, a hub is formed by cutting a solid metal material having a columnar shape. DHS1 is a type of free-machining steel, and is a stainless steel having cutting performance improved by inclusions such as MnS.

In recent years, an increase in the number of hard disks resulting from an increase in the capacity of hard disk drive devices has led to an increase in the axial length of the hub for placing the hard disks. A conventional method for forming a hub by cutting involves removing the interior of a cylindrical portion of the hub. Therefore, the greater the axial length of the hub, the longer the processing time and the greater the material loss. In addition, cutting a free-machining steel may generate particles due to separation of inclusions. JP 2010-035367 A discloses a technique for forming a hub of a spindle motor by cold forging DHS1 steel. Cold forging is thought to reduce material loss due to cutting.

### SUMMARY

However, in recent spindle motors including more than eight hard disks each having a diameter of 3.5 inches, the axial length of the hub is too long to form the hub by cold forging DHS1 steel. Producing a hub having a long axial length by cold forging DHS1 steel may cause the material to break in some cases.

The present disclosure has been made in view of the above circumstances, and an object is to provide a spindle motor and a hard disk drive device. The spindle motor includes a hub. The hub is formed by cold forging and has a long axial length.

The present disclosure provides a spindle motor including a fixed portion and a rotating portion including a hub. The hub is made of low-carbon steel having a carbon content of 0.23% or less, and the hub is a cold-forged product.

According to the present disclosure, since low-carbon steel having a carbon content of 0.23% or less has excellent cold forgeability, it is possible to provide a spindle motor and a hard disk drive device including a hub having a long axial length and enabling a larger number of hard disks to be mounted.

### BRIEF DESCRIPTION OF DRAWINGS

FIG. 1 is a perspective view illustrating a hard disk drive device according to an embodiment of the present disclosure.

FIG. 2A is a cross-sectional view illustrating a hard disk drive device according to an embodiment of the present disclosure, and FIG. 2B is an enlarged view of the portion indicated by the arrow B in FIG. 2A.

FIG. 3 is a cross-sectional view illustrating a spindle motor according to an embodiment of the present disclosure.

FIG. 4 is an enlarged view illustrating a modification example of the portion indicated by the arrow IV in FIG. 3.

FIG. 5 is an enlarged view illustrating another modification example of the portion indicated by the arrow V in FIG. 3.

### DESCRIPTION OF EMBODIMENTS

### 1. Hard Disk Drive Device

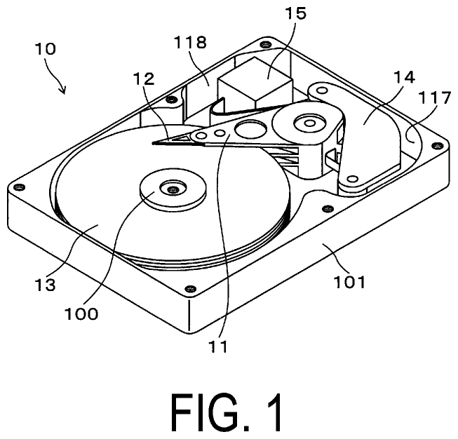

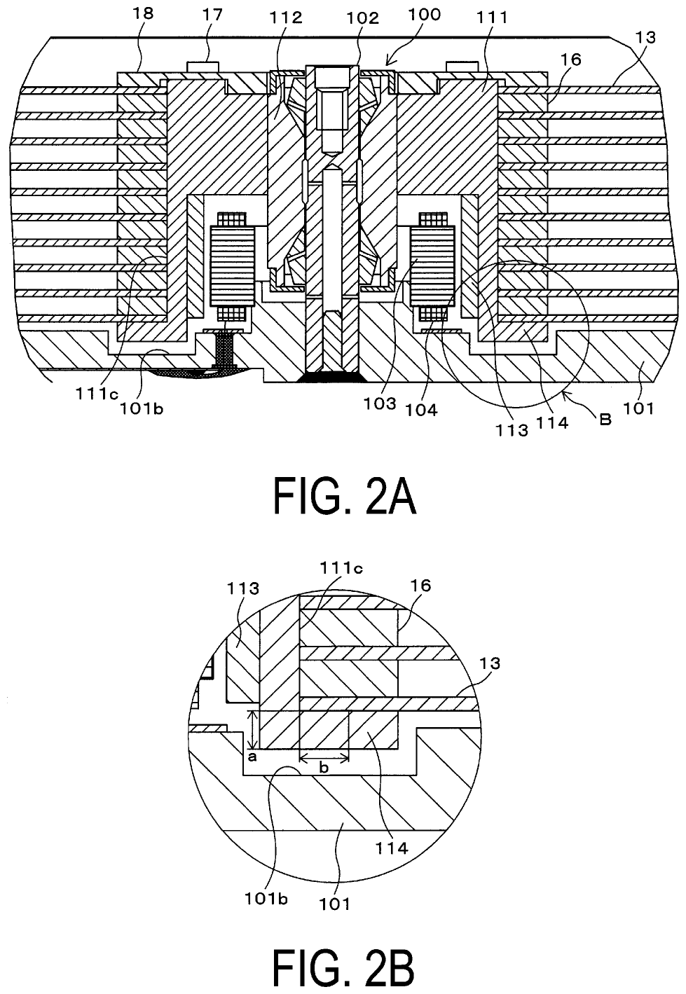

FIG. 1 is a perspective view illustrating the overall configuration of a hard disk drive device 10 employing a spindle motor according to an embodiment of the present disclosure, and FIG. 2 is a cross-sectional view taken along a plane including a rotation axis. As illustrated in FIGS. 1 and 2, the hard disk drive device 10 includes a spindle motor 100 and a plurality of hard disks 13 in a housing 118. The housing 118 is formed at a base portion 101 including a recessed portion 117. The plurality of hard disks 13 is mounted at the spindle motor 100 and rotated.

The hard disk drive device 10 also includes a swing arm 11 configured to support a plurality of magnetic heads 12 each facing a respective hard disk 13, an actuator 14 configured to drive the swing arm 11, and a control unit 15 configured to control these units. In the hard disk drive device 10, a cover portion (not illustrated) mounted at the base portion 101 so as to seal the housing 118 forms a casing (a space from the upper surface of the base portion 101 to the bottom surface of the cover portion) with the base portion 101. The height of the casing is from 1.5 to 2.0 inches, and the casing is filled with helium.

### 2. Spindle Motor

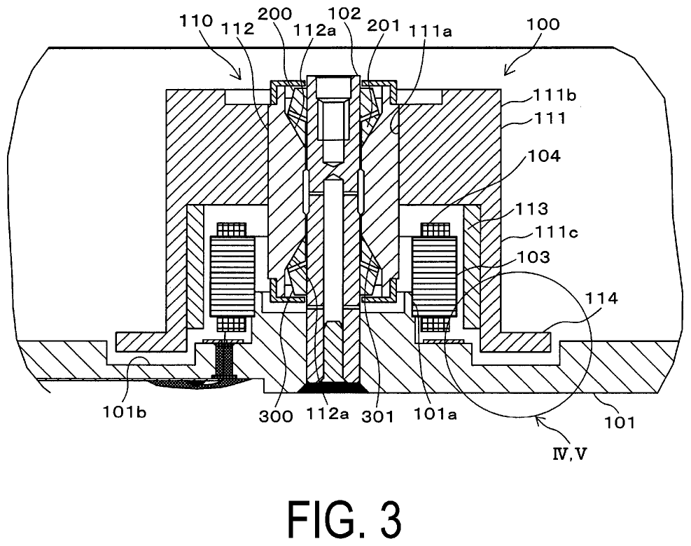

FIG. 3 is a cross-sectional view illustrating the spindle motor 100 according to the embodiment, taken along a plane including a rotation axis. The spindle motor 100 includes the base portion 101 and a shaft (fixed portion) 102 fixed to the base portion 101. At the shaft 102, conical bearing members 201 and 301 are fixed so as to be spaced apart from each other in the axial direction to constitute bearings 200 and 300, respectively.

At the base portion 101, a cylindrical portion 101a extending upward in the axial direction of the shaft 102 is formed, and a stator core 103 is fixed at an outer periphery of the cylindrical portion 101a. The stator core 103 is formed by layering, in the axial direction, a plurality of thin sheet-like soft magnetic materials (for example, electromagnetic steel sheets) each having an annular shape, and includes a plurality of pole teeth protruding outward in the radial direction. The plurality of pole teeth are provided at equal intervals along a circumferential direction, and a coil 104 is wound around each pole teeth.

A rotating portion of the spindle motor 100 includes a rotor 110. The rotor 110 includes a hub 111 including a through-hole 111a at a central portion, and a sleeve 112 fixed to the through-hole 111a by an appropriate method such as press fitting or bonding. The hub 111 includes a flat plate portion 111b extending outward in the radial direction, a cylindrical portion 111c extending downward from the outer periphery of a lower end of the flat plate portion 111b, and a flange portion 114 extending outward in the radial direction from a lower end portion of the cylindrical portion 111c.

The hub 111 is composed of low-carbon steel having a carbon content of 0.23 mass % or less, for example from 0.07 to 0.23 mass %, preferably from 0.08 to 0.23 mass %. The hub 111 is preferably composed of S20C. S20C has a composition consisting of, in mass %, C: 0.18 to 0.23%, Si: 0.15 to 0.35%, Mn: 0.3 to 0.6%, P: less than 0.03%, S: less than 0.035%, and the remainder: Fe and unavoidable impurities. Low-carbon steel having such a composition has excellent cold forgeability, and can be cold-forged to form the hub 111 having a long axial length (length of the cylindrical portion 111c).

The hub 111 is preferably composed of S10C. S10C has a composition consisting of, in mass %, C: 0.08 to 0.13%, Si: 0.15 to 0.35%, Mn: 0.3 to 0.6%, P: less than 0.03%, S: less than 0.035%, and the remainder: Fe and unavoidable impurities. S10C has excellent cold forgeability compared to S20C, and by selecting S10C, the axial length of the hub 111 can be further increased to mount more hard disks 13.

Note that, as materials other than S10C, S12C (C: 0.10 to 0.15%), S15C (C: 0.13 to 0.18%), S17C (C: 0.15 to 0.20%), S09CK (C: 0.07 to 0.12%), S15CK (C: 0.13 to 0.18%), S20CK (C: 0.18 to 0.23%), or the like can be used.

The entire region of the hub 111 excluding the through-hole 111a is covered with a resin film or a plating film of metal having higher corrosion resistance than carbon steel. Here, “metal having higher corrosion resistance” means metal nobler than a base material. Electroless nickel plating, chrome plating, or the like can be used as the metal plating. Epoxy resin, acrylic resin, or the like can be used as the resin film. Such a film can be provided on both of the hub 111 and the sleeve 112 in a state where the sleeve 112 is fixed to the hub 111, or can be provided on the hub 111 only. Since carbon steel is more likely to rust than stainless steel, the above film is provided to improve rust prevention properties. Further, the film described above can prevent the generation of particles.

The hub 111 is manufactured by cold-forging the above-described low-carbon steel. The through-hole 111a is formed by thinning the low-carbon steel in a vertical direction by cold forging and punching a hole through the low-carbon steel, and is finished by lathe turning. The inner peripheral surface of the cylindrical portion 111c is also finished by lathe turning. Note that the hub 111 and the sleeve 112 can also be integrally formed of low-carbon steel.

The sleeve 112 has a substantially cylindrical shape. An inner peripheral surface of the sleeve 112 includes a tapered surface 112a in slide contact with the conical bearing members 201 and 301. With this configuration, the rotor 110 is rotatably supported by the conical bearing members 201 and 301 while being prevented from moving in the vertical direction. The sleeve 112 is made of stainless steel. By forming the sleeve 112 as a member separate from the hub 111, cold forging of the hub 111 is facilitated, and processing of the sleeve 112 is also facilitated. Further, the sleeve 112 is made of stainless steel and thus need not be plated, and high dimensional accuracy of the inner peripheral surface of the sleeve 112 can be ensured by lathe turning.

However, when a film is provided on both of the hub 111 and the sleeve 112 in a state where the sleeve 112 is fixed to the hub 111 as described above, removing the film provided on the sleeve 112 can improve dimensional accuracy. Alternatively, when the film provided on the hub 111 and the sleeve 112 is harder than the base material, it is preferable to leave the film provided on the inner peripheral surface of the sleeve 112. Accordingly, the wear resistance of the inner peripheral surface of the sleeve 112 is ensured, and the surfaces of the conical bearing members 201 and 301 need not be coated with a solid lubricant film such as a diamond-like carbon (DLC) film, reducing manufacturing costs.

In a case where the hub 111 and the sleeve 112 are integrally formed and a film is provided over the entire area of the hub 111 and the sleeve 112, the wear resistance of the inner peripheral surface of the sleeve 112 can be ensured by using a film harder than the base material.

A rotor magnet 113 having an annular shape is fixed at an inner peripheral surface side of the cylindrical portion 111c. The rotor magnet 113 is magnetized in a manner such that adjacent portions alternately have opposing magnetic poles such as S-N-S-N . . . along a circumferential direction. The inner periphery of the rotor magnet 113 faces the outer periphery of the pole teeth of the stator core 103 in a state of being spaced apart from each other. When the coil 104 is supplied with a drive current, a drive force for causing the rotor magnet 113 to rotate is generated, and the rotor 110 rotates relative to the shaft 102 and the base portion 101 with the shaft 102 serving as an axis. This mechanism is similar to that of a typical spindle motor.

As illustrated in FIG. 2, the hard disks 13 are placed on the flange portion 114, and a total of 10 hard disks 13 are sequentially stacked with spacers 16 interposed between the hard disks 13. Note that the number of hard disks 13 need not be 10, and may be 11 or more. In addition, the uppermost hard disk 13 is fixed to the rotor 110 by using a clamp 18 attached to the upper surface of the rotor 110 using a screw 17. Also, an annular groove 101b is formed in the upper surface of the base portion 101 at a position overlapping with the flange portion 114 in the axial direction such that at least the lower surface of the flange portion 114 is housed in the annular groove 101b. This makes it possible to place more hard disks 13 on the flange portion 114.

The hard disk 13 may be made of metal such as aluminum, but is preferably made of glass. The thermal expansion coefficient of glass is close to the thermal expansion coefficient of low-carbon steel, and combining the hard disks 13 made of glass and the hub 111 made of low-carbon steel can improve accuracy when assembling the hard disks 13.

Here, as illustrated in FIG. 2B, when a minimum thickness of the flange portion 114 at an end portion at the cylindrical portion 111c side is defined as (a) and a distance from the center in a radial direction of a portion in contact with the hard disk 13 of the flange portion 114 to the cylindrical portion 111c is defined as (b), (a)/(b) is set to 0.37 to 0.42. With the above configuration, the thickness of the flange portion 114 is defined to be thin. Specifically, the minimum thickness of the flange portion 114 is from 0.8 to 1.0 mm, preferably from 0.85 to 0.9 mm. The reason why the thickness of the flange portion 114 can be reduced as described above is because the rigidity of the flange portion 114 is increased through work-hardening by cold forging with no break in a metal flow line.

### 3. Operation and Effects

In the spindle motor 100 having the configuration described above, the hub 111 is made of low-carbon steel having a carbon content of 0.23% or less, and thus has excellent cold forgeability. In addition, the hub 111 having a long axial length can be obtained by cold forging. In the hard disk drive device 10, the height of the casing can be set to from 1.5 to 2.0 inches, and thus the number of hard disks 13 to be mounted can be increased. In addition, unlike JP 2006-254625 A where a solid material is cut, the problem of material loss and the problem of particle generation or the like due to separation of inclusions such as a free-machining component after machining do not occur.

Further, since the rigidity of the hub 111 formed by cold forging is increased through work-hardening with no break in the metal flow line, it is possible to reduce the thickness of the flange portion 114 and increase the thickness of the base portion 101 at a position of the annular groove 101b opposing the flange portion 114. Accordingly, the rigidity of the base portion 101 can be increased, and the helium enclosed in the casing of the hard disk drive device 10 can be suppressed from leaking.

### 4. Modification Examples

The present disclosure is not limited to the embodiment described above, and it is possible to make various modifications as described below.

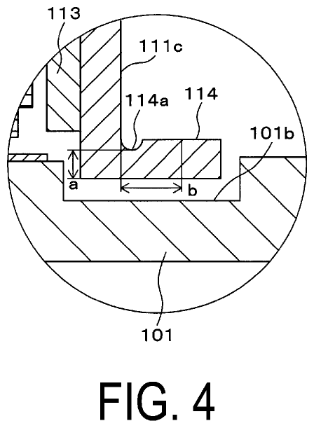

i) As illustrated in FIG. 4, an annular groove 114a having a semicircular cross-section can be formed in the upper surface of the flange portion 114 at an end portion at the cylindrical portion 111c side. The annular groove 114a is a relief for avoiding contact with the inner peripheral corner portion of the hard disk 13. In the flange portion 114 described above, when a thickness of the flange portion 114 at the center of the annular groove 114a is defined as (a) and a distance from the center in a radial direction of a portion in contact with the hard disk 13 of the flange portion 114 to the cylindrical portion 111c is defined as (b), (a)/(b) is set to 0.37 to 0.42. Also, in the flange portion 114 described above, the thickness (a) of the flange portion 114 is defined to be thin.

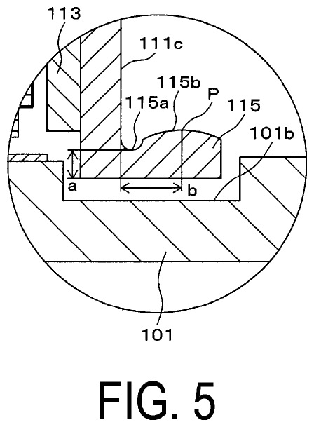

ii) A flange portion 115 illustrated in FIG. 5 includes an annular groove 115a having a semicircular cross-section formed in the upper surface of the flange portion 115 at an end portion at the cylindrical portion 111c side, and a projecting portion 115b having an arc-shaped cross-section projecting upward and formed at a portion at an outer side in the radial direction relative to the annular groove 115a. The projecting portion 115b is in contact with the hard disk 13 at a contact point P. Thus, in this modification example, “the center in a radial direction of a portion in contact with the hard disk 13” refers to the contact point P.

In the flange portion 115 described above, when a thickness of the flange portion 115 at the center of the annular groove 115a is defined as (a) and a distance from the contact point P of the flange portion 115 to the cylindrical portion 111c is defined as (b), (a)/(b) is set to 0.37 to 0.42. Also, in the flange portion 115 described above, the thickness (a) of the flange portion 115 is defined to be thin.

iii) In the embodiment described above, the present disclosure is applied to a fixed-shaft type spindle motor including the shaft 102 fixed to the base portion 101, but the present disclosure can also be applied to a rotating-shaft type spindle motor including the shaft 102 rotatably supported by a bearing fixed to the base portion 101.

The present disclosure can be employed in a spindle motor and a hard disk drive device, and in particular, can be preferably employed in a hard disk drive device including a casing having a height of 1.5 to 2.0 inches.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A spindle motor comprising:
a fixed portion; and
a rotating portion including a hub, wherein
the hub is made of low-carbon steel having a carbon content of 0.23 mass % or less, and
the hub is a cold-forged product.

2. The spindle motor according to claim 1, wherein the hub is made of low-carbon steel having a carbon content of 0.13 mass % or less.

3. The spindle motor according to claim 1, wherein a resin film or a plating film of metal nobler than a base material is provided on a surface of the hub.

4. The spindle motor according to claim 3, wherein
the rotating portion includes a through-hole formed at a center of the hub, and a sleeve fixed in the through-hole,
the film is harder than the base material and is formed on an inner peripheral surface of the sleeve,
the fixed portion includes a shaft and a conical bearing member fixed to the shaft, and
the conical bearing member is not coated with a solid lubricant film.

5. The spindle motor according to claim 3, wherein
the rotating portion includes a sleeve integrally formed with the hub,
the film is harder than the base material and is formed on an inner peripheral surface of the sleeve,
the fixed portion includes a shaft and a conical bearing member fixed to the shaft, and
the conical bearing member is not coated with a solid lubricant film.

6. The spindle motor according to claim 3, wherein the film is electroless nickel plating.

7. The spindle motor according to claim 4, wherein the film is electroless nickel plating.

8. The spindle motor according to claim 5, wherein the film is electroless nickel plating.

9. The spindle motor according to claim 1, wherein
the hub includes a flat plate portion extending outward in a radial direction, a cylindrical portion extending downward in an axial direction from an outer side in the radial direction of the flat plate portion, and a flange portion extending outward in the radial direction from a lower side in the axial direction of the cylindrical portion, and
when a minimum thickness of the flange portion at an end portion at a side of the cylindrical portion is defined as (a) and a distance in the radial direction from a center in a radial direction of a portion capable of coming into contact with a recording disk of the flange portion to the cylindrical portion is defined as (b), (a)/(b) is from 0.37 to 0.42, and the minimum thickness of the flange portion at the end portion at the cylindrical portion side is from 0.8 to 1.0 mm.

10. The spindle motor according to claim 9, wherein the minimum thickness of the flange portion at the end portion at the cylindrical portion side is from 0.85 to 0.9 mm.

11. The spindle motor according to claim 9, further comprising a sleeve fixed to an inner side in the radial direction of the flat plate portion of the hub, wherein
the sleeve is formed of stainless steel.

12. The spindle motor according to claim 10, further comprising a sleeve fixed to an inner side in the radial direction of the flat plate portion of the hub, wherein
the sleeve is formed of stainless steel.

13. A hard disk drive device comprising the spindle motor according to claim 1.

14. A hard disk drive device comprising the spindle motor according to claim 3.

15. A hard disk drive device comprising the spindle motor according to claim 5.

16. A hard disk drive device comprising the spindle motor according to claim 7.

17. The hard disk drive device according to claim 13, further comprising a hard disk made of glass.

18. The hard disk drive device according to claim 13, wherein 10 or more of hard disks are provided.

19. The hard disk drive device according to claim 13, wherein a height of a casing is from 1.5 to 2.0 inches.
